(19) United States
(12) Patent Application Publication
(10) Pub. No.: US 2015/0120748 A1
(43) Pub. Date: Apr. 30, 2015

(54) INDEXING SPREADSHEET STRUCTURAL ATTRIBUTES FOR SEARCHING

(71) Applicant: Microsoft Corporation, Redmond, WA (US)

(72) Inventors: Steven Paul Kraynak, Sammamish, WA (US); Anatoly V. Grabar, Redmond, WA (US); Ozgur Basaran, Seattle, WA (US); Mark Alan Mullins, Sammamish, WA (US); Leif Christian Brenne, Snoqualmie, WA (US)

(73) Assignee: Microsoft Corporation, Redmond, WA (US)

(21) Appl. No.: 14/068,264

(22) Filed: Oct. 31, 2013

(51) Int. Cl. G06F 17/30

(52) U.S. Cl. CPC G06F 17/30321
USPC 707/741

(57) ABSTRACT

Technologies are described herein for extracting and/or calculating statistics regarding attributes present in a spreadsheet document and indexing the structural or functional attributes. A search component is also provided for receiving search queries of attributes to search an index to find spreadsheet documents having attributes that meet the search query requirements.

### BACKGROUND

Businesses during everyday operation may generate spreadsheet documents to capture data or information relating to business operations. As the size of a business grows, or as time progresses, the number and size of these spreadsheet documents may grow. For a relatively large business, the amount of information captured and stored in these spreadsheet documents may be significant.

When searching for particular spreadsheet documents, typically the spreadsheet documents may be found if text or uniquely identifying numerical information is contained within the spreadsheet document. In one example, one or more spreadsheet documents may contain a field entitled “Sales Area Four.” A user may want to access the one or more spreadsheet documents that contain data related to that field. A user may be presented with a search interface, enter in a text string, and request that a search be performed to find spreadsheet documents that contain the text string. If the spreadsheet documents do not contain the specified text string, no spreadsheet documents would be returned by the search.

Another way to search for spreadsheet documents is to search for numerical data stored in the spreadsheet documents. Typically, in order for a search using numerical data to be effective, the spreadsheet document would need to have uniquely identifiable numerical data. For example, a search for the number “1” may retrieve almost all of the spreadsheet documents of an organization, as a relatively large portion of spreadsheet documents contain the number “1.” By contrast, a search on a number that is unique to a certain spreadsheet document may be a viable means of searching for various spreadsheets. For example, data in a particular field of a particular spreadsheet document may start with a certain order of numbers, e.g. “144321.” A search using this sequence of numbers may better narrow the search results from a potentially unmanageable number to a smaller number of more relevant spreadsheet documents. The two mechanisms described above for searching spreadsheet documents can be very limiting, especially when searching a large corpus of spreadsheet documents.

It is with respect to these and other considerations that the disclosure made herein is presented.

### SUMMARY

Technologies are described herein for extracting and/or calculating statistics regarding structural and/or functional attributes present in a spreadsheet document and indexing the attributes. A search component is also provided that is configured to receive search queries specifying attributes and to locate spreadsheet documents having attributes that match the attributes specified in the search queries.

In accordance with some concepts and technologies described herein, the presently disclosed subject matter accesses a spreadsheet data store and extracts functional and/or structural attributes of one or more spreadsheet documents contained therein. The attributes are then indexed for use in processing search queries. The index may then be utilized to process search queries specifying functional and/or structural attributes of spreadsheet.

It should be appreciated that the above-described subject matter may also be implemented as a computer-controlled apparatus, a computer process, a computing system, or as an article of manufacture such as a computer-readable storage medium. These and various other features will be apparent from a reading of the following detailed description and a review of the associated drawings.

This summary is provided to introduce a selection of concepts in a simplified form that are further described below. This summary is not intended to identify key features or essential features of the claimed subject matter, nor is it intended that this summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram showing one configuration for a computing system configured to provide the functionality disclosed herein for indexing and searching structural and/or functional attributes of spreadsheet documents.

FIG. 2 is an illustrative screen diagram showing a search user interface (UI) that may be utilized to input search queries to the system shown in FIG. 1, in accordance with some embodiments.

FIG. 3 is an illustrative screen diagram showing a search results UI for presenting search results of a query performed by the system shown in in FIG. 1, in accordance with some embodiments.

FIG. 4 is a flow diagram showing aspects of a method for indexing and searching spreadsheet documents based upon structural and/or functional attributes, in accordance with some embodiments.

FIG. 5 is a computer architecture diagram showing aspects of a device capable of executing the software components presented herein, in accordance with some embodiments.

FIG. 6 is a network diagram illustrating aspects of a distributed computing environment capable of implementing aspects of the embodiments presented herein, in accordance with some embodiments.

FIG. 7 is a computer architecture diagram illustrating aspects of a computing device architecture capable of implementing aspects of the embodiments presented herein.

### DETAILED DESCRIPTION

The following detailed description is directed to technologies for searching spreadsheet documents using structural and/or functional attributes of a spreadsheet provided in an index. Through the use of an index as described herein, more robust searching of spreadsheet documents may be possible than through the use of currently available technologies.

As used herein, the term “attribute” refers to a property of a spreadsheet. An attribute may be defined by a user or may be a pre-defined property of a spreadsheet. An attribute may be structural or functional. A “structural attribute” is a property of a spreadsheet relating to how the spreadsheet is assembled. For example, and without limitation, a structural attribute may be the inter-relational nature between various cells of a spreadsheet. A “functional attribute” is a property of a spreadsheet relating to the operation of the spreadsheet. For example, and without limitation, a functional attribute may be a formula used to calculate a cell value. Other examples of attributes may include, but are not limited to, a user, the count of formulas (calculations), count of sheets, count of named items (named ranges and references), count of data connections, count of linked spreadsheet documents, count of code routines and/or functions, count of hidden items, and existence of items restricted/protected by password. As used herein, a “count” refers to the summation of the occurrences of an item. For example, a count of sheets may refer to the sum total of the sheets of a spreadsheet.

In some configurations, the subject matter disclosed herein may also provide for the indexing of one or more functional and/or structural attributes of a spreadsheet. The results of the extraction/calculation described above may be stored in an index. For example, spreadsheets may be indexed according to the name of the document, the number of various attributes, and the like. In some configurations, the spreadsheets are not indexed until a search is performed. As will be described in greater detail below, a search interface may also be provided to a user to receive search criteria to identify spreadsheets having attributes that meet specified search criteria.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, aspects of a computing system, computer-readable storage medium, and computer-implemented methodologies for indexing spreadsheet attributes and for searching for documents having specified attributes will be presented.

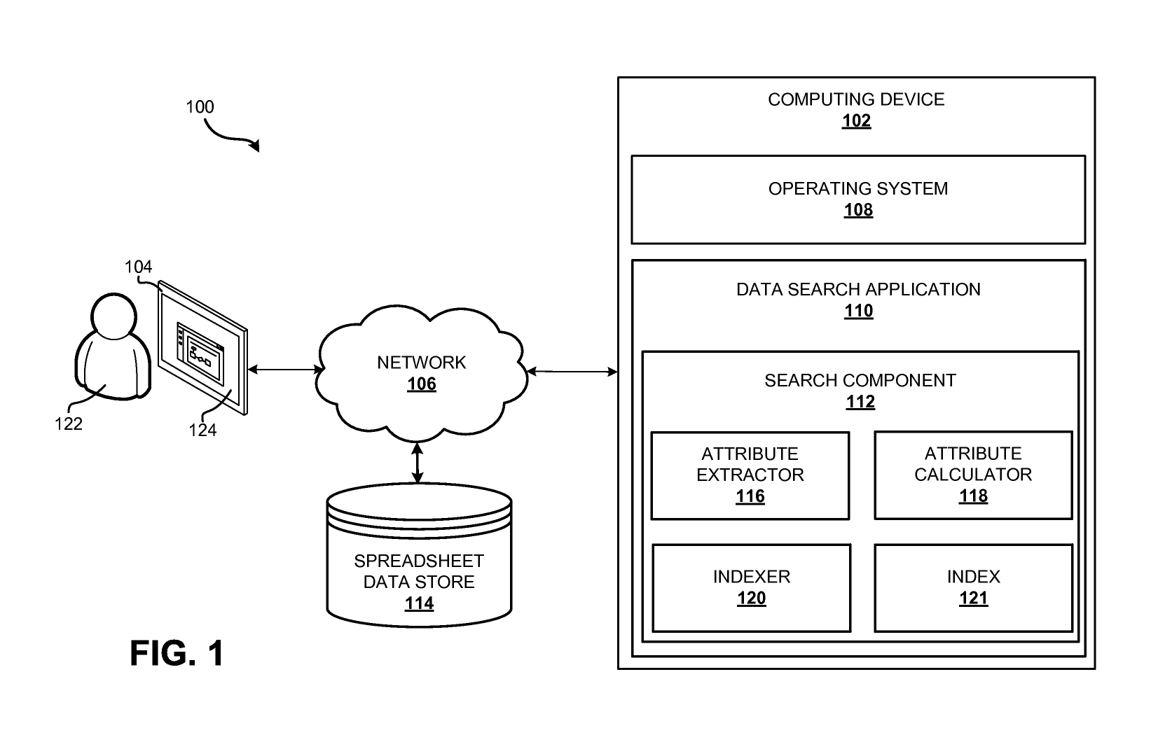

Referring now to FIG. 1, aspects of one configuration for a system 100 configured to provide the functionality disclosed herein for indexing and searching structural and/or functional attributes of spreadsheet documents will be described. As shown in FIG. 1, the computing device 102 operates on or in communication with a computing device 104 through a network 106. The computing device 102 and the computing device 104 may be a desktop computer, a laptop computer, a notebook computer, an ultra-portable computer, a netbook computer, or a computing device such as a mobile telephone, a tablet device, a slate device, a portable video game device, or the like.

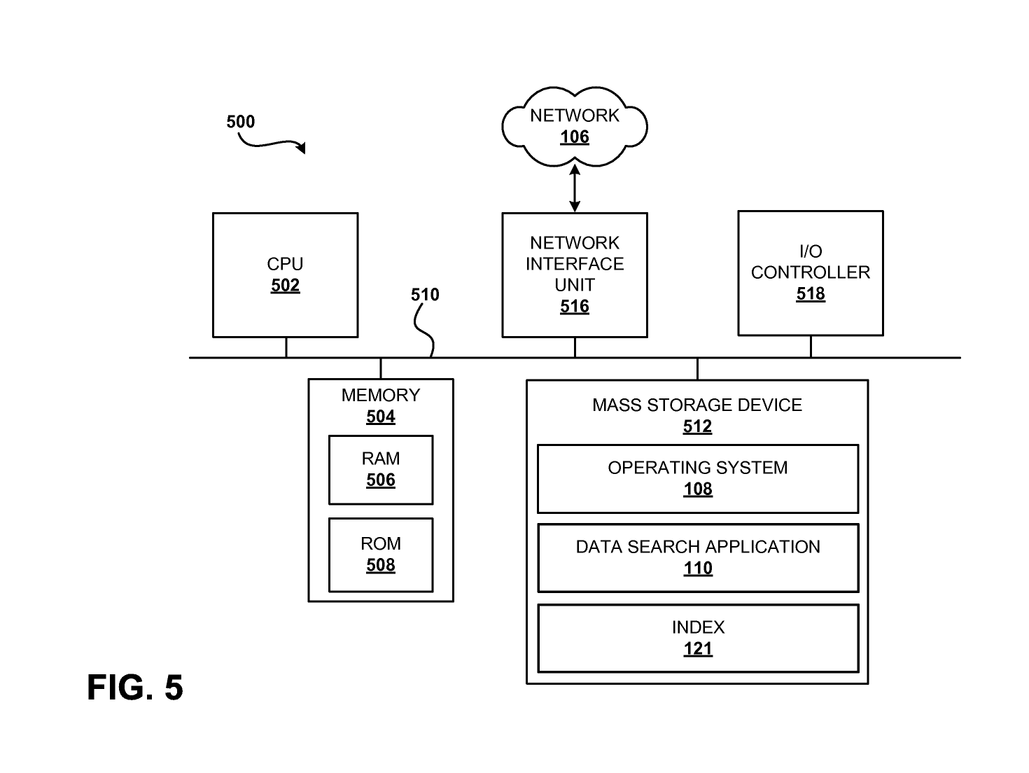

It should be understood that in some configurations, a single computing device may be used to implement various aspects of the subject matter described herein. The presently disclosed subject matter is not limited to the use of two or more separate computing devices. It should be understood that the concepts and technologies disclosed herein are not limited to an operating environment connected to a network or any external computing system, as various embodiments of the concepts and technologies disclosed herein can be implemented locally on a single computing device 102. Several illustrative architectures for implementing the computing device 102 and the computing device 104 are illustrated and described herein below with reference to FIGS. 5-7.

An operating system 108 executes on the computing device 102. The operating system 108 is an executable program for controlling functions on the computing device 102. The computing device 102 may also execute a data search application 110. The data search application 110 is an application configured to index spreadsheet documents and to process search queries of the spreadsheet documents. The data search application 110, in some examples, may be, but is not limited to, one or more productivity application programs that are part of the MICROSOFT OFFICE family of products from Microsoft Corporation in Redmond, Wash., such as MICROSOFT SHAREPOINT. In other examples, the data search application 110 may be the GOOGLE SITES API provided by Google, Inc. of Menlo Park, Calif. It should be understood that the examples provided herein are illustrative, and should not be construed as limiting in any way. Further, it should be understood that the data search application 110 may be a component of another application, the presently disclosed subject matter not being limited to an application having features limited to the aspects described herein.

The data search application 110 may include a search component 112 configured to receive queries for searching spreadsheets contained in the spreadsheet data store 114 and to process the search queries to return one or more search results. The spreadsheet data store 114 is an appropriate database or other type of data store storing one or more spreadsheets. Although the spreadsheet data store 114 is shown in FIG. 1 as a separate component, the spreadsheet data store 114 may be implemented as a part of the computing device 102, the computing device 104, or may be a data store accessible through the network 106. The network 106 may be an intranet, extranet, the Internet, or other suitable network capable of providing communication capabilities between the various computing devices shown in FIG. 1.

In order to search spreadsheets stored in the spreadsheet data store 114, the search component 112 may include an attribute extractor 116 and an attribute calculator 118. The attribute extractor 116 is configured to access spreadsheets stored in the spreadsheet data store 114 and to extract attribute information from the spreadsheets. The attribute information extracted may vary depending on the configuration of the system 100. For example, and without limitation, the attribute information extracted may be a standard set of attributes provided to the attribute extractor 116 that are extracted when a spreadsheet is saved in the spreadsheet data store 114. In another example, the extracted attributes may be attributes provided during a search query. In this example, the attributes may be defined at search time rather than at storage time, as provided in the example above. In another example, the attributes extracted may vary depending on a property of a spreadsheet saved in the spreadsheet data store 114. For example, a spreadsheet containing “Sales Information” may have a different set of attributes that are extracted than a spreadsheet containing “Corporate Financial Information.”

The attribute calculator 118 may receive the attributes extracted by the attribute extractor 116 and perform various calculations to generate statistical data regarding the spreadsheets stored in the spreadsheet data store 114. The calculations performed may vary from a simple summing of the occurrences of certain attributes to more complex calculations such as a calculation that uses the input of several attributes. The calculations may also include a comparison of the result of the calculation to various set points. These and other types of calculations are considered to be within the scope of the presently disclosed subject matter.

The calculations might also be performed at different times. For example, the calculations described above may be performed when a spreadsheet is loaded into and stored in the spreadsheet data store 114. In another example, the calculations may be performed at search time. In some configurations, the search query may include inputs to the attribute calculator 118 that may be used to modify the calculations to be performed on the spreadsheets stored in the spreadsheet data store 114. For example, an initial calculation may be performed to determine the number of occurrences of a specific attribute in a spreadsheet. A secondary calculation may then be performed to compare the number of occurrences calculated previously against a pre-determined level. One of these levels may be a determination of risk. The attribute calculator 118 may calculate the number of formula errors in a particular spreadsheet. The attribute calculator 118 may take this number and determine a risk level, such as low, medium or high, based on that calculation.

The attribute calculator 118 might also utilize receive and utilize weighting factors that place emphasis on important attributes while moving emphasis away from, relative to the important attributes, less important attributes. For example, and without limitation, the number of formula errors may connote a less useful spreadsheet, whereas the number of formulas used may connote a more useful spreadsheet. In response to such a determination, the number of formula errors may have a relatively low weighting factor when compared to a weighting factor used for the number of formulas. The weighting factor may also be a negative weighting factor. For example, if two spreadsheets have the same number of formulas but one has a higher number of formula errors, a negative weighting factor may cause the spreadsheet with the higher number of formula errors to show up at a lower ranked location in a search result compared to the spreadsheet with the lower number of spreadsheet errors.

The indexer 120 receives as an input the calculations performed by the attribute calculator 118 and indexes those calculations. The indexing of spreadsheet calculations by the indexer 120 may provide a means in which a search can be performed on the spreadsheet data store 114 for spreadsheets meeting criteria set forth in a search query. The indexer 120 may create an index 121 to store data relating to the calculations in a delimited, tabular format.

The indexer 120 may index the calculations at various times and update the index 121 accordingly. For example, the indexer 120 may index the calculations when a calculation is performed by the attribute calculator 118. In another example, the indexer may index the calculations when a search query is received by the search component 112. In this configuration, the search query may include instructions to the indexer 120 to modify the manner in which the indexer 120 indexes the calculations. The index 121 may be updated in response to the indexer 120 performing the indexing operations.

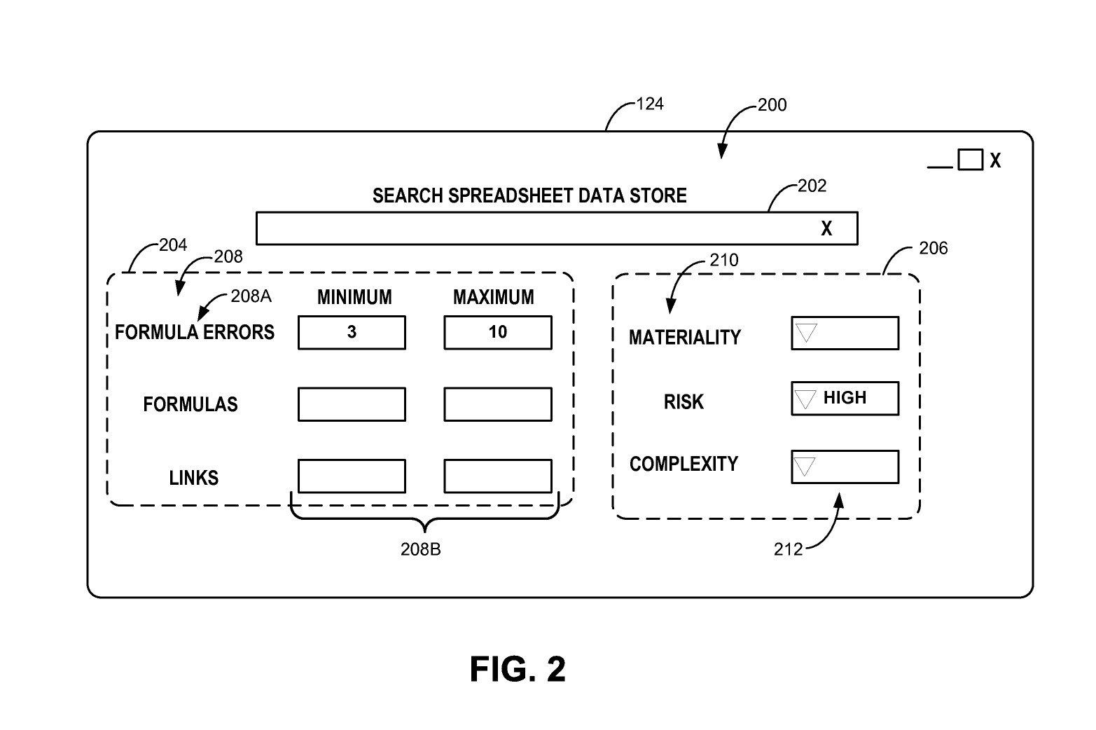

As discussed above, a search query may be received from a user 122, from a program component, or from another entity. The user 122 may be presented with a search user interface (UI), shown by way of example in FIG. 2 below, on a display 124 of the computing device 104. The search query may vary depending on the particular configuration of the operating environment. The search query may include various textual, numerical, or conditional inputs relating to attributes of one or more spreadsheets.

FIG. 2 is an illustrative screen diagram showing a search user interface (UI) 200 that may be used to input search queries on the index 121 of the system 100 of FIG. 1. The search UI 200 may be rendered on the display 124 of the computing device 104 of FIG. 1. The search UI 200 may include a search query input 202, a search modifier input 204, and an attribute modifier input 206. It should be understood that the hashed lines used in FIG. 2 and the other figures presented herein are provided to distinguish various parts from each other and do not connote or delineate a functional or physical relationship.

The search query input 202 may be configured to receive one or more search terms provided by the user 122 or other entity. The search terms may include numerical information or textual information. For example, and without limitation, a search query may be constructed by the search terms, “SALES” and “FORMULAS>200”. The first term, SALES, may limit the search to spreadsheets having the term “SALES.” The second term, FORMULAS>200, may limit the search to spreadsheets in which the calculated number of formulas is greater than 200. In this example, the search query is used to limit the search results to spreadsheets having calculated attributes meeting the criteria set forth in the search query.

As an alternative to a “free form” structure of the search query input 202, the search modifier input 204 may be used. As noted in the example above, the user 122 may only want spreadsheets with more than 200 formulas returned in the search results. The search modifier input 204 may include a list of attributes 208 that may be calculated. The user 122 may input a range or a number in range inputs 208B to limit the search results to spreadsheets meeting the criteria entered in the search modifier input 204. For example, the attribute 208A, relating to formula errors, has an input of three for a minimum and ten for a maximum in the range inputs 208B. The search component 112 may filter the search results to spreadsheets having a minimum of three formula errors up to a maximum of ten formula errors. It should be noted that the subject matter presented herein is not limited to the requirement of the entry of both a minimum or maximum number, as one may be used independently of the other.

The search results may also be narrowed by using the attribute modifier input 206. As noted above, the attribute calculator 118 may perform an initial calculation to determine raw data associated with an attribute. When so configured, the attribute calculator 118 may use the raw data to perform additional, or secondary, calculations. The attribute modifier input 206 includes an attribute modifier list 210 and an input interface 212. The attribute modifier list 210 includes various secondary calculations, or determinations, that may be performed on the raw data generated by the attribute calculator 118.

For example, the attribute modifier 210A, relating to risk, has an input of “HIGH.” In that example, the search component 112 may limit the search results to spreadsheets that are determined to have a risk level of HIGH. The attribute calculator 118 may perform these secondary calculations when a spreadsheet is loaded into and saved in the spreadsheet data store 114 or at search time. The results of a search may be provided in search

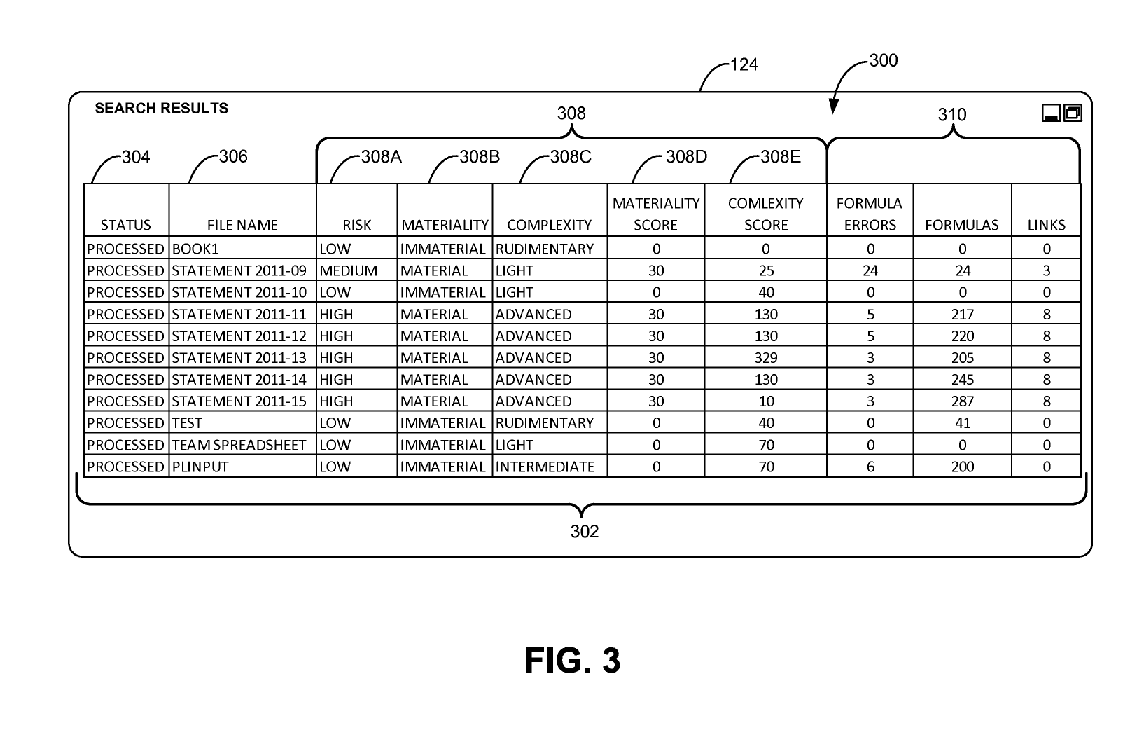

FIG. 3 is an illustrative screen diagram showing a search results UI 300 rendering search results 302 of a query on the system 100 of FIG. 1, in accordance with some embodiments. The search results UI 300 may render the search results 302 on the display 124 of the computing device 104 of FIG. 1. The search results may include a status identifier 304, a file name identifier 306, a secondary calculation portion 308, and an initial calculation portion 310. The status identifier 304 may indicate a current status of calculations being performed on the spreadsheet identified in the file name identifier 306.

As discussed above with regard to FIG. 2, the search results 302 may include one or more secondary calculations that use raw data to perform additional calculations on the raw data. These secondary calculations may be presented in the secondary calculation portion 308. These secondary calculations may correspond to the attribute modifier list 210 of FIG. 2. The secondary calculations illustrated are risk 308A, materiality 308B, and complexity 308C. The secondary calculation portion 308 may also include the numerical information associated with the secondary calculations.

For example, the materiality score 308D and the complexity score 308E relate to the materiality 308B and the complexity 308C, respectively. The risk 308A may be determined using the numerical information from the other secondary calculations. It should be understood that the attributes, primary calculations, and secondary calculations are exemplary only and are not intended to limit the scope of the present disclosure to those attributes or calculations.

The initial calculation portion 310 has rendered therein the raw data calculated by the attribute calculator 118. The raw data rendered in the initial calculation portion 310 may correspond to the list of attributes 208 rendered in the search UI 200 of FIG. 2. These raw numbers in the initial calculation portion 310 may include the weighting factors described above. As with other aspects described herein, the raw data rendered in the initial calculation portion 310 may be calculated when a spreadsheet is loaded and stored in the spreadsheet data store 114 or at other times, such as at search time.

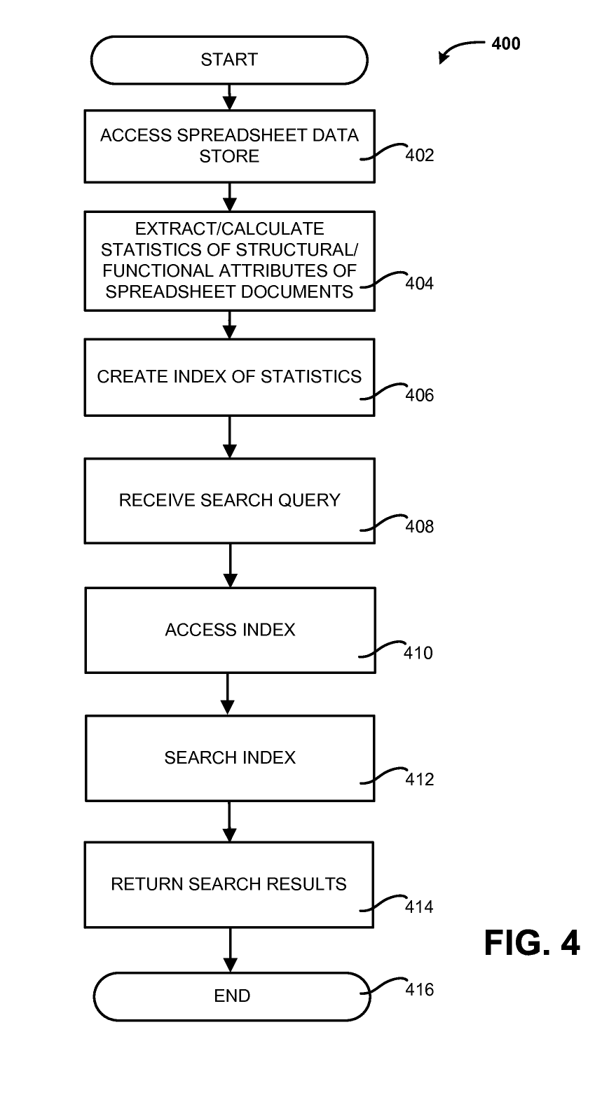

FIG. 4 is a flow diagram showing aspects of a method 400 for indexing and searching structural and/or functional attributes present in spreadsheet documents, in accordance with some embodiments. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

The operations of the method 400 are described herein below as being implemented, at least in part, by the data search application 110, the search component 112, the attribute extractor 116, the attribute calculator 118, the indexer 120, and the computing device 102, or combinations thereof. Unless specified, the operations of the method 400 need not be performed in any particular sequence or time period.

The method 400 begins at operation 402, where the spreadsheet data store 114 is accessed. As mentioned above, he spreadsheet data store 114 may have stored therein one or more spreadsheets. In some examples, the spreadsheets may be constructed from data provided by an organization such as a company.

From operation 402, the method 400 proceeds to operation 404, where the functional and/or structural attributes extracted by the attribute extractor 116 and statistics of those extracted attributed are calculated by the attribute calculator 118. The attribute extractor 116 may be configured to extract one or more attributes specific to the spreadsheet itself or as a default setting applied to all the spreadsheets that are loaded and stored in the spreadsheet data store 114. For example, the attributes extracted and calculated may be determined from a search query received by the data search application 110. In another example, the attributes extracted and calculated may be common to all spreadsheets.

From operation 404, the method 400 proceeds to operation 406, where the indexer 120 creates an index of statistics regarding the attributes. The indexer 120 receives as an input the calculations performed by the attribute calculator 118. The indexer 120 receives the calculations are stores the calculations in a database table. It should be understood that the presently disclosed subject matter does not require the use of the indexer 120. In some configurations, the calculations may remain in an unstructured or partially unstructured state.

From operation 406, the method 400 proceeds to operation 408, where a search query is received at the data search application 110. The data search application 110 invokes a search function to search the spreadsheet data store 114 for spreadsheets that meet the criteria set forth in the search query. The search query may include textual or numerical information and may include other operators that narrow the scope of the search results. For example, the search query may include operators received from the search modifier input 204 or the attribute modifier input 206.

From operation 408, the method 400 proceeds to operation 410, where the index 121 is accessed. As noted above, the index 121 may be generated at various times. For example, the index 121 may be generated or updated when a spreadsheet is stored in the spreadsheet data store 114. In another example, the index 121 may be generated when a search request is received.

From operation 410, the method 400 proceeds operation 412, where the index 121 generated from the spreadsheet data store 114 is searched according to the criteria set forth in the search query and other criteria that may be included in a search. The method 400 then proceeds from operation 412 to operation 414, where the search results 302 of the query are returned in the search results UI 300. The method 400 then proceeds to operation 416, where it ends.

FIG. 5 shows an illustrative computer architecture 500 for a device capable of executing the software components described herein for indexing and searching functional and/or structural spreadsheet attributes. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit (“CPU”) 502, a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing, by way of example and not by way of limitation, the operating system 108, the data search application 110, and the index 121 from FIG. 1.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for the non-transitory storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer architecture 500. For purposes of the claims, the phrase “computer storage medium,” and variations thereof, does not include waves or signals per se and/or communication media.

According to various embodiments, the computer architecture 500 may operate in a networked environment using logical connections to remote computers through a network such as the network 106. The computer architecture 500 may connect to the network 106 through a network interface unit 516 connected to the bus 510. It should be appreciated that the network interface unit 516 also may be utilized to connect to other types of networks and remote computer systems. The computer architecture 500 also may include an input/output controller 518 for receiving and processing input from a number of other devices, including a keyboard, mouse, or electronic stylus. Similarly, the input/output controller 518 may provide output to a display screen, a printer, or other type of output device.

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this description.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

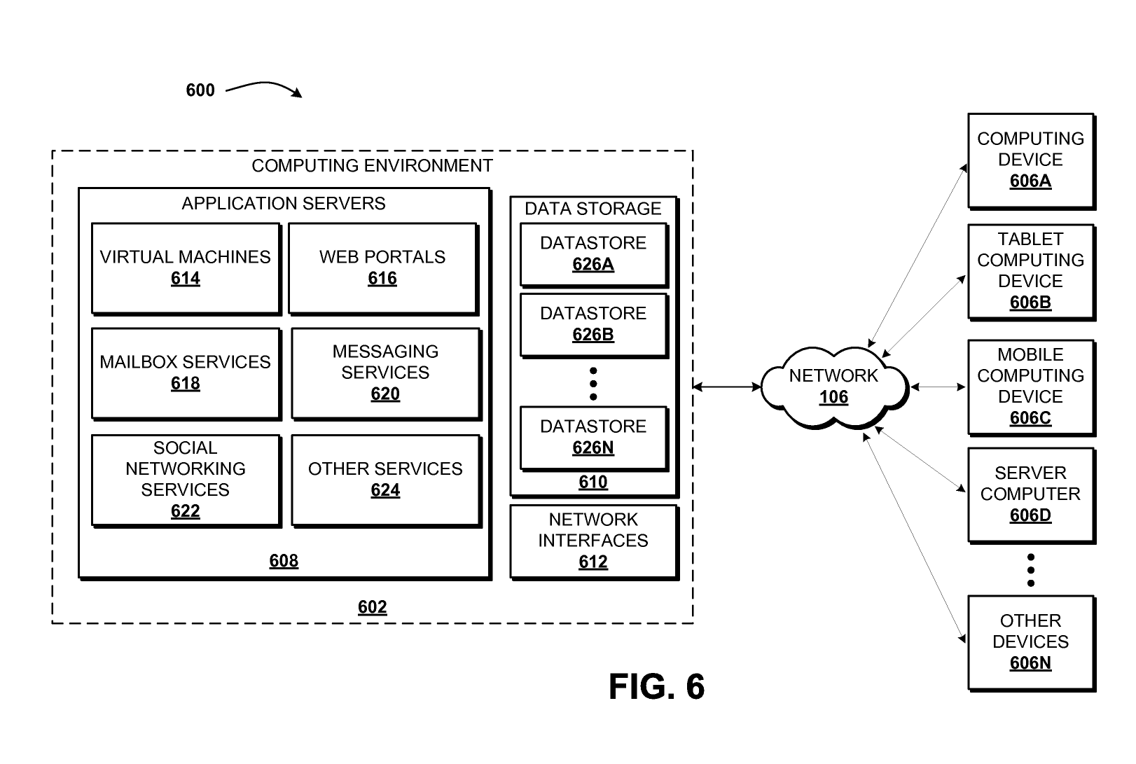

FIG. 6 illustrates an illustrative distributed computing environment 600 capable of executing the software components described herein for searching for providing the concepts and technologies described herein. Thus, the distributed computing environment 600 illustrated in FIG. 6 can be used to provide the functionality described herein. The distributed computing environment 600 thus may be utilized to execute any aspects of the software components presented herein.

According to various implementations, the distributed computing environment 600 includes a computing environment 602 operating on, in communication with, or as part of the network 106. The network 106 also can include various access networks. One or more client devices 606A-606N (hereinafter referred to collectively and/or generically as “clients 606”) can communicate with the computing environment 602 via the network 106 and/or other connections (not illustrated in FIG. 6). In the illustrated embodiment, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. It should be understood that the illustrated clients 606 and computing architectures illustrated and described herein are illustrative, and should not be construed as being limited in any way.

In the illustrated embodiment, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated embodiment, the application servers 608 host one or more virtual machines 614 for hosting applications or other functionality. According to various implementations, the virtual machines 614 host one or more applications and/or software modules for providing the functionality described herein. It should be understood that this embodiment is illustrative, and should not be construed as being limiting in any way. The application servers 608 also host or provide access to one or more Web portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also can include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some embodiments, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above embodiments are illustrative, and should not be construed as being limited in any way.

As shown in FIG. 6, the application servers 608 also can host other services, applications, portals, and/or other resources (“other resources”) 624. The other resources 624 can include, but are not limited to, the data search application 110. It thus can be appreciated that the computing environment 602 can provide integration of the concepts and technologies disclosed herein with various mailbox, messaging, social networking, and/or other services or resources.

As mentioned above, the computing environment 602 can include the data storage 610. According to various implementations, the functionality of the data storage 610 is provided by one or more data stores operating on, or in communication with, the network 106. The functionality of the data storage 610 also can be provided by one or more server computers configured to host data for the computing environment 602. The data storage 610 can include, host, or provide one or more real or virtual data stores 626A-626N (hereinafter referred to collectively and/or generically as “data stores 626”). The data stores 626 are configured to host data used or created by the application servers 608 and/or other data. Although not illustrated in FIG. 6, the data stores 626 also can host or store the spreadsheet data store 114 of FIG. 1.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 600 to utilize the functionality described herein.

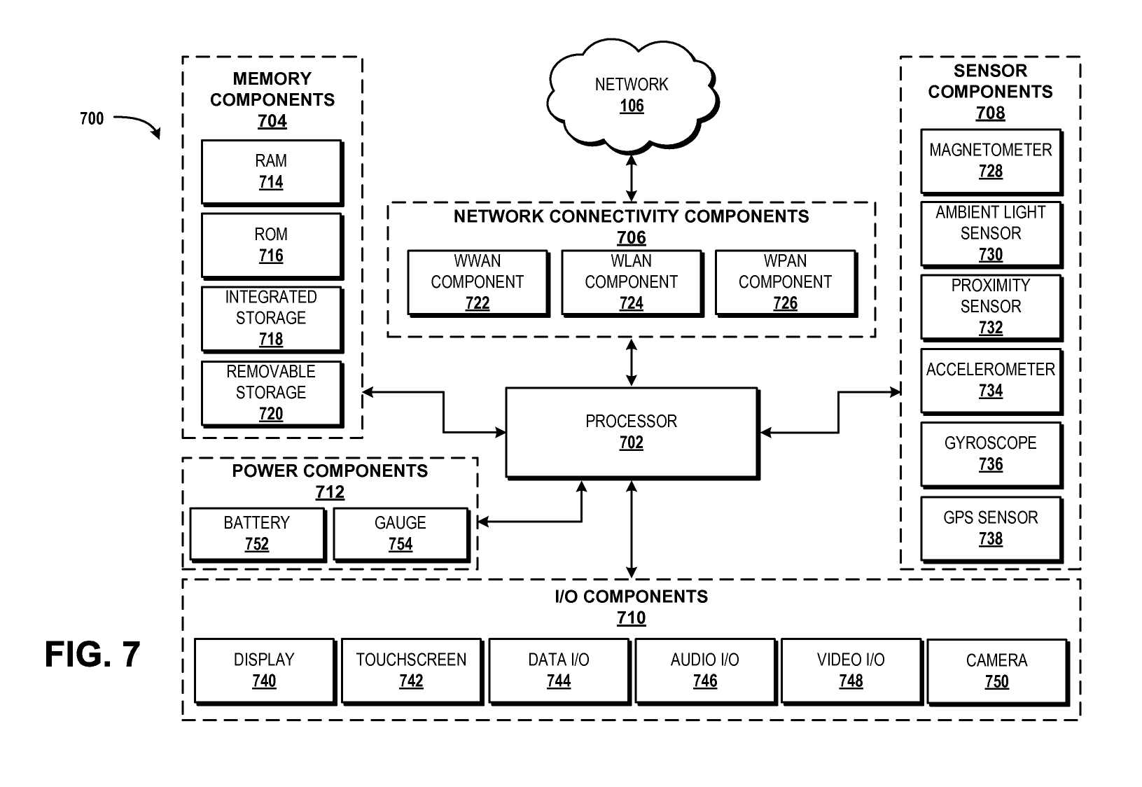

Turning now to FIG. 7, an illustrative computing device architecture 700 for a computing device that is capable of executing various software components described herein for extracting and/or calculating statistics regarding attributes present in a spreadsheet document, indexing the attributes, structural or functional and providing a search component configured to receive search queries of attributes to find spreadsheet documents having attributes that meet the search query requirements. The computing device architecture 700 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. Moreover, the computing device architecture 700 is applicable to any of the clients 606 shown in FIG. 6. Furthermore, aspects of the computing device architecture 700 may be applicable to traditional desktop computers, portable computers (e.g., laptops, notebooks, ultra-portables, and netbooks), server computers, and other computer systems, such as described herein with reference to FIG. 1. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output (“I/O”) components 710, and power components 712. In the illustrated embodiment, the processor 702 is in communication with the memory components 704, the network connectivity components 706, the sensor components 708, the I/O components 710, and the power components 712. Although no connections are shown between the individuals components illustrated in FIG. 7, the components can interact to carry out device functions. In some embodiments, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some embodiments, the processor 702 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some embodiments, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some embodiments, the processor 702 is fabricated, in part, utilizing a package-on-package (“PoP”) integrated circuit packaging technique. Moreover, the processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some embodiments, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some embodiments, the RAM 714 or a portion thereof, the ROM 716 or a portion thereof, and/or some combination the RAM 714 and the ROM 716 is integrated in the processor 702. In some embodiments, the ROM 716 is configured to store a firmware, an operating system or a portion thereof (e.g., operating system kernel), and/or a bootloader to load an operating system kernel from the integrated storage 718 or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some embodiments, the removable storage 720 is provided in lieu of the integrated storage 718. In other embodiments, the removable storage 720 is provided as additional optional storage. In some embodiments, the removable storage 720 is logically combined with the integrated storage 718 such that the total available storage is made available and shown to a user as a total combined capacity of the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various embodiments, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 106, which may be a WWAN, a WLAN, or a WPAN. Although a single network 106 is illustrated, the network connectivity components 706 may facilitate simultaneous communication with multiple networks. For example, the network connectivity components 706 may facilitate simultaneous communications with multiple networks via one or more of a WWAN, a WLAN, or a WPAN.

The network 106 may be a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 106 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 106 may be configured to provide voice and/or data communications with any combination of the above technologies. The network 106 may be configured to or adapted to provide voice and/or data communications in accordance with future generation technologies.

In some embodiments, the WWAN component 722 is configured to provide dual-multi-mode connectivity to the network 106. For example, the WWAN component 722 may be configured to provide connectivity to the network 106, wherein the network 106 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 106 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 724 is configured to connect to the network 106 via the WI-FI access points. Such connections may be secured via various encryption technologies including, but not limited, WI-FI Protected Access (“WPA”), WPA2, Wired Equivalent Privacy (“WEP”), and the like.

The network 106 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 738. It is contemplated that other sensors, such as, but not limited to, temperature sensors or shock detection sensors, also may be incorporated in the computing device architecture 700.

The magnetometer 728 is configured to measure the strength and direction of a magnetic field. In some embodiments the magnetometer 728 provides measurements to a compass application program stored within one of the memory components 704 in order to provide a user with accurate directions in a frame of reference including the cardinal directions, north, south, east, and west. Similar measurements may be provided to a navigation application program that includes a compass component. Other uses of measurements obtained by the magnetometer 728 are contemplated.

The ambient light sensor 730 is configured to measure ambient light. In some embodiments, the ambient light sensor 730 provides measurements to an application program stored within one the memory components 704 in order to automatically adjust the brightness of a display (described below) to compensate for low-light and high-light environments. Other uses of measurements obtained by the ambient light sensor 730 are contemplated.

The proximity sensor 732 is configured to detect the presence of an object or thing in proximity to the computing device without direct contact. In some embodiments, the proximity sensor 732 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 732 are contemplated.

The accelerometer 734 is configured to measure proper acceleration. In some embodiments, output from the accelerometer 734 is used by an application program as an input mechanism to control some functionality of the application program. For example, the application program may be a video game in which a character, a portion thereof, or an object is moved or otherwise manipulated in response to input received via the accelerometer 734. In some embodiments, output from the accelerometer 734 is provided to an application program for use in switching between landscape and portrait modes, calculating coordinate acceleration, or detecting a fall. Other uses of the accelerometer 734 are contemplated.

The gyroscope 736 is configured to measure and maintain orientation. In some embodiments, output from the gyroscope 736 is used by an application program as an input mechanism to control some functionality of the application program. For example, the gyroscope 736 can be used for accurate recognition of movement within a video game application or some other application. In some embodiments, an application program utilizes output from the gyroscope 736 and the accelerometer 734 to enhance control of some functionality of the application program. Other uses of the gyroscope 736 are contemplated.

The GPS sensor 738 is configured to receive signals from GPS satellites for use in calculating a location. The location calculated by the GPS sensor 738 may be used by any application program that requires or benefits from location information. For example, the location calculated by the GPS sensor 738 may be used with a navigation application program to provide directions from the location to a destination or directions from the destination to the location. Moreover, the GPS sensor 738 may be used to provide location information to an external location-based service, such as E911 service. The GPS sensor 738 may obtain location information generated via WI-FI, WIMAX, and/or cellular triangulation techniques utilizing one or more of the network connectivity components 706 to aid the GPS sensor 738 in obtaining a location fix. The GPS sensor 738 may also be used in Assisted GPS (“A-GPS”) systems.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some embodiments, the display 740 and the touchscreen 742 are combined. In some embodiments two or more of the data I/O component 744, the audio I/O interface component 746, and the video I/O component 748 are combined. The I/O components 710 may include discrete processors configured to support the various interface described below, or may include processing functionality built-in to the processor 702.

The display 740 is an output device configured to present information in a visual form. In particular, the display 740 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some embodiments, the display 740 is a liquid crystal display (“LCD”) utilizing any active or passive matrix technology and any backlighting technology (if used). In some embodiments, the display 740 is an organic light emitting diode (“OLED”) display. Other display types are contemplated.

The touchscreen 742 is an input device configured to detect the presence and location of a touch. The touchscreen 742 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 742 is incorporated on top of the display 740 as a transparent layer to enable a user to use one or more touches to interact with objects or other information presented on the display 740. In other embodiments, the touchscreen 742 is a touch pad incorporated on a surface of the computing device that does not include the display 740. For example, the computing device may have a touchscreen incorporated on top of the display 740 and a touch pad on a surface opposite the display 740.

In some embodiments, the touchscreen 742 is a single-touch touchscreen. In other embodiments, the touchscreen 742 is a multi-touch touchscreen. In some embodiments, the touchscreen 742 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 742. As such, a developer may create gestures that are specific to a particular application program.

In some embodiments, the touchscreen 742 supports a tap gesture in which a user taps the touchscreen 742 once on an item presented on the display 740. The tap gesture may be used for various reasons including, but not limited to, opening or launching whatever the user taps. In some embodiments, the touchscreen 742 supports a double tap gesture in which a user taps the touchscreen 742 twice on an item presented on the display 740. The double tap gesture may be used for various reasons including, but not limited to, zooming in or zooming out in stages. In some embodiments, the touchscreen 742 supports a tap and hold gesture in which a user taps the touchscreen 742 and maintains contact for at least a pre-defined time. The tap and hold gesture may be used for various reasons including, but not limited to, opening a context-specific menu.

In some embodiments, the touchscreen 742 supports a pan gesture in which a user places a finger on the touchscreen 742 and maintains contact with the touchscreen 742 while moving the finger on the touchscreen 742. The pan gesture may be used for various reasons including, but not limited to, moving through screens, images, or menus at a controlled rate. Multiple finger pan gestures are also contemplated. In some embodiments, the touchscreen 742 supports a flick gesture in which a user swipes a finger in the direction the user wants the screen to move. The flick gesture may be used for various reasons including, but not limited to, scrolling horizontally or vertically through menus or pages. In some embodiments, the touchscreen 742 supports a pinch and stretch gesture in which a user makes a pinching motion with two fingers (e.g., thumb and forefinger) on the touchscreen 742 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 742. As such, the above gestures should be understood as being illustrative and should not be construed as being limiting in any way.

The data I/O interface component 744 is configured to facilitate input of data to the computing device and output of data from the computing device. In some embodiments, the data I/O interface component 744 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 746 is configured to provide audio input and/or output capabilities to the computing device. In some embodiments, the audio I/O interface component 744 includes a microphone configured to collect audio signals. In some embodiments, the audio I/O interface component 744 includes a headphone jack configured to provide connectivity for headphones or other external speakers. In some embodiments, the audio I/O interface component 746 includes a speaker for the output of audio signals. In some embodiments, the audio I/O interface component 744 includes an optical audio cable out.

The video I/O interface component 748 is configured to provide video input and/or output capabilities to the computing device. In some embodiments, the video I/O interface component 748 includes a video connector configured to receive video as input from another device (e.g., a video media player such as a DVD or BLURAY player) or send video as output to another device (e.g., a monitor, a television, or some other external display). In some embodiments, the video I/O interface component 748 includes a High-Definition Multimedia Interface (“HDMI”), mini-HDMI, micro-HDMI, DisplayPort, or proprietary connector to input/output video content. In some embodiments, the video I/O interface component 748 or portions thereof is combined with the audio I/O interface component 746 or portions thereof.

The camera 750 can be configured to capture still images and/or video. The camera 750 may utilize a charge coupled device (“CCD”) or a complementary metal oxide semiconductor (“CMOS”) image sensor to capture images. In some embodiments, the camera 750 includes a flash to aid in taking pictures in low-light environments. Settings for the camera 750 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The battery gauge 754 can be configured to measure battery parameters such as current, voltage, and temperature. In some embodiments, the battery gauge 754 is configured to measure the effect of a battery's discharge rate, temperature, age and other factors to predict remaining life within a certain percentage of error. In some embodiments, the battery gauge 754 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via a power I/O component (not illustrated).

Based on the foregoing, it should be appreciated that concepts and technologies for extracting and/or calculating statistics regarding attributes present in a spreadsheet document, indexing the structural and/or functional attributes, and providing a search component configured to search for spreadsheet documents having attributes that satisfy specified search queries have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method, the method comprising:
extracting a structural or a functional attribute from at least a portion of one or more spreadsheets;
calculating statistics for the extracted structural or functional attributes from the at least a portion of the one or more spreadsheets;
creating an index of the statistics;
receiving a search query;
accessing the index in response to receiving the search query;
searching the index; and
returning at least one search result in response to the search query.

2. The computer-implemented method of claim 1, wherein the structural attribute or the functional attribute comprises one or more of a user, a count of formulas, a count of sheets, a count of named items, a count of data connections, a count of linked spreadsheet documents, a count of code routines and/or functions, a count of hidden items, and an existence of items restricted or protected by a password.

3. The computer-implemented method of claim 1, wherein the structural attribute or the functional attribute comprise a standard set of attributes that are extracted when a spreadsheet is saved in the spreadsheet data store, attributes provided in the search query, and attributes that are extracted depending on a property of a spreadsheet.

4. The computer-implemented method of claim 1, wherein calculating statistics of extracted structural or functional attributes from the at least a portion of the one or more spreadsheets is performed when a spreadsheet is loaded and saved into the spreadsheet data store.

5. The computer-implemented method of claim 1, wherein calculating statistics of extracted structural or functional attributes from the at least a portion of the one or more spreadsheets is performed when the search query is received.

6. The computer-implemented method of claim 1, wherein calculating statistics of extracted structural or functional attributes from the at least a portion of the one or more spreadsheets comprises performing an initial calculation and a secondary calculation.

7. The computer-implemented method of claim 6, wherein the initial calculation is a determination of a number of occurrences of the structural attribute or the functional attribute.

8. The computer-implemented method of claim 6, wherein the secondary calculation comprises a comparison of a number of occurrences of the structural attribute or the functional attribute against a pre-determined level.

9. The computer-implemented method of claim 6, wherein calculating statistics of extracted structural or functional attributes from the at least a portion of the one or more spreadsheets comprises receiving a weighting factor.

10. The computer-implemented method of claim 1, wherein creating an index of statistics is performed when a spreadsheet is loaded and saved into the spreadsheet data store or is performed when the search query is received.

11. The computer-implemented method of claim 1, wherein the search query comprises numerical and textual inputs.

12. The computer-implemented method of claim 1, wherein the search query comprises a range.

13. The computer-implemented method of claim 1, wherein the query comprises an attribute modifier input.

14. A computer-readable storage medium having computer readable instructions stored thereon which, when executed by a computer, cause the computer to:
extract a structural or a functional attribute from at least a portion of one or more spreadsheets;
calculate statistics of the extracted structural or functional attributes from the at least a portion of the one or more spreadsheets;
create an index of the statistics;
receive a search query;
access the index in response to receiving the search query;
search the index; and
return at least one search result in response to the search query.

15. The computer-readable storage medium of claim 14, wherein the structural attribute or the functional attribute comprises one or more of a user, a count of formulas, a count of sheets, a count of named items, a count of data connections, a count of linked spreadsheet documents, a count of code routines and/or functions, a count of hidden items, and an existence of items restricted or protected by a password.

16. The computer-readable storage medium of claim 14, wherein the structural attribute or the functional attribute comprises a standard set of attributes that are extracted when a spreadsheet is saved in the spreadsheet data store, attributes provided in the search query, and attributes that are extracted depending on a property of a spreadsheet.

17. The computer-readable storage medium of claim 14, wherein the statistics of extracted structural or functional attributes from the at least a portion of the one or more spreadsheets are calculated when a spreadsheet is loaded and saved into the spreadsheet data store or when the search query is received.

18. The computer-readable storage medium of claim 14, wherein to calculate statistics of extracted structural or functional attributes from the at least a portion of the one or more spreadsheets comprises performing an initial calculation and a secondary calculation, wherein the initial calculation is a determination of a number of occurrences of the structural attribute or the functional attribute, and wherein the secondary calculation comprises a comparison of a number of occurrences of the structural attribute or the functional attribute against a pre-determined level.

19. The computer-readable storage medium of claim 14, wherein the index of statistics is created when a spreadsheet is loaded and saved into the spreadsheet data store or when the search query is received.

20. A computer, comprising:
a processor; and
a computer-readable storage medium in communication with the processor, the computer-readable storage medium having computer-executable instructions stored thereupon which, when executed by the processor, cause the processor to
execute a data search application configured to perform search queries on an index,
execute a search component configured to receive a search query of the index,
execute an attribute extractor configured to access a spreadsheet stored in a spreadsheet data store and to extract attribute information from the spreadsheet,
execute an attribute calculator configured to receive an attribute extracted by the attribute extractor and perform a calculation to generate statistical data regarding the spreadsheet stored in the spreadsheet data store,
execute an indexer configured to receive the calculation performed by the attribute calculator and to generate the index using the calculation, and
render a search user interface a search query input, a search modifier input, and an attribute modifier input.
